(19) United States
(12) Patent Application Publication
(10) Pub. No.: US 2022/0151371 A1
(43) Pub. Date: May 19, 2022

(54) APPLICATOR DEVICE

(71) Applicant: DENSO International America Inc., Southfield, MI (US)

(72) Inventor: Luz Fabiola DOMINGUEZ Aguayo, Guanajuato (MX)

(21) Appl. No.: 17/207,981

(22) Filed: Mar. 22, 2021

Related U.S. Application Data
(60) Provisional application No. 63/114,076, filed on Nov. 16, 2020.

(51) Int. Cl. A46B 11/00; F16N 3/00

(52) U.S. Cl. CPC A46B 11/001; A46B 2200/40; A46B 2200/20; F16N 3/00

(57) ABSTRACT

An applicator device for applying a fluid to an object has a hollow body, an applicator, a sensor, and a notification system. The hollow body stores the fluid therein. The applicator discharges the fluid. The sensor is configured to detect a fluid surface of the fluid. The notification system is configured to generate a notification signal based on a detection signal from the sensor.

### CROSS-REFERENCE TO RELATED APPLICATIONS

This application claims the benefit of U.S. Provisional Application No. 63/114,076 filed on Nov. 16, 2020. The entire disclosure of the above application is incorporated herein by reference.

### FIELD

The present disclosure relates to an applicator device that applies a fluid or semi-fluid to an object during manufacturing processes.

### BACKGROUND

Some manufacturing processes, e.g., assembling, of products require lubricating a part or parts of the products. At such a lubrication step, operators apply lubricant (e.g., grease) to the part or the parts by hand using a tool such as a brush. For example, the lubricant is stored in a container and the operators take the lubricant out by the tool and apply the lubricant to the part or the parts. Since the lubrication is operated by hand, some issues may arise.

### SUMMARY

In an example, an applicator device for applying a fluid to an object is disclosed. For example, an applicator device for applying a fluid to an object has a hollow body, an applicator, a sensor, and a notification system. The hollow body stores the fluid therein. The applicator discharges the fluid. The sensor is configured to detect a fluid surface of the fluid. The notification system is configured to generate a notification signal based on a detection signal from the sensor.

Further areas of applicability of the present disclosure will become apparent from the detailed description, the claims and the drawings. The detailed description and specific examples are intended for purpose of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view illustrating an applicator device and a notification system.

FIG. 2 is a cross-sectional view illustrating a flow adjuster of the applicator device.

In the drawings, reference numbers may be reused to identify similar and/or identical elements.

### DETAILED DESCRIPTION

According to conventional techniques, operators may take lubricant out from a container by hand every time the operators apply the lubricant to a part or parts of an object. As such, an amount of the lubricant applied each time may vary. This may results in a quality issue due to an excess amount of the lubricant or due to a deficient amount of the lubricant. For another example, since the operators may touch the lubricant with bare hands while taking out and applying the lubricant, health issues such as inflamed skin.

The present disclosure addresses such issues and provides a unique and innovative applicator device. Example embodiments will now be described with reference to the accompanying drawings.

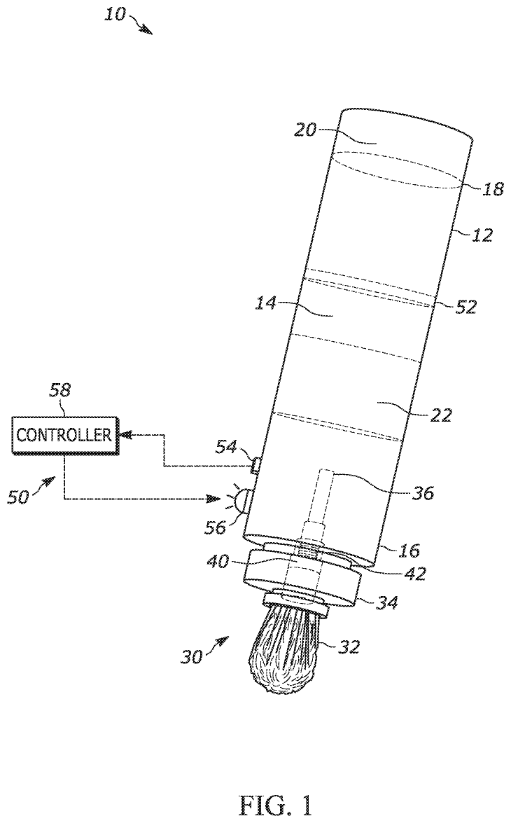

As shown in FIG. 1, an applicator device 10 has a hollow body 12. For example, the hollow body 12 may be a bottle in shape and stores a fluid or a semi-fluid 14 therein. The applicator device 10 will be described as a lubricator device for applying a lubricant (e.g., grease) hereafter, so the fluid or the semi-fluid 14 may be the lubricant. However, it should be understood that the applicator device 10 can be used for any other purposes and the fluid or the semi-fluid 14 is not limited to a lubricant. The hollow body 12 has an applicator 30 at one end 16 and a bottom cap 20 at another end 18.

The bottom cap 20 is a separate piece provided separately from the hollow body 12 and is attached to the hollow body 12 to be detachable. The bottom cap 20 is attached to the hollow body 12 by a known manner. For example, the bottom cap 20 is a screw cap. The bottom cap 20 is removed to fill up the hollow body 12 with the lubricant and is attached to the hollow body 12 after filling up the hollow body 12. The lubricant is stored in a container such as a steel drum. The lubricant may be taken out from the container using a dispenser tap.

The hollow body 12 may have a grip portion 22 which is designed ergonomically so a user can handle the hollow body 12 comfortably.

The applicator 30 discharges the lubricant and applies the lubricant to an object. The applicator 30 has a tip 32, a connector 34, and a fluid inlet 36. The fluid inlet 36 is located in the hollow body 12 and takes in the lubricant from the hollow body 12 to the applicator 30. For example, the tip 32 is a brush in shape. The connector 34 fixes the applicator 30 to the hollow body 12. For example, the connector 34 may be a screw cap.

The applicator 30 has a flow adjuster 40. The flow adjuster 40 is accommodated in the connector 34 and has a spring 42 and a ball check valve 44. The spring 42 is normally closes the applicator 30, in a known manner, so that the lubricant does not flow through the applicator 30 to the tip 32. When the tip 32 is pressed against the object, the spring 42 is shrunk and allows the lubricant in the hollow body 12 to flow into the applicator 30 from the fluid inlet 36.

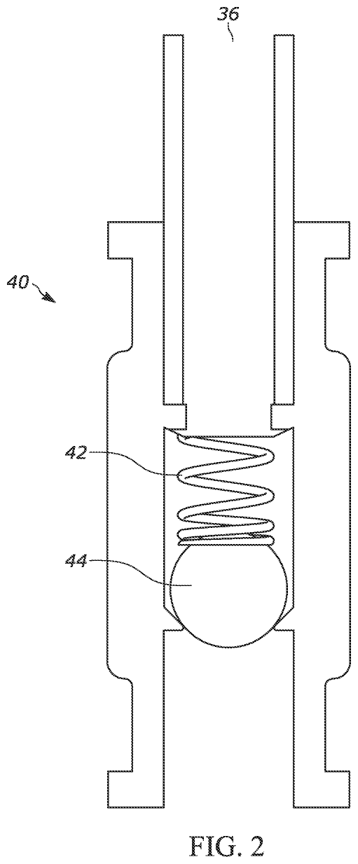

As shown in FIG. 2, the ball check valve 44 is accommodated in the flow adjuster 40. The ball check valve 44 obtains, in a know manner, the fixed amount of the lubricant under Poiseuille's Law. Accordingly, the applicator 30 is able to discharge the same amount of the lubricant each time so that an mount of the lubricant applied to each object becomes equal.

The applicator device 10 has a notification system 50 that notifies the user when running out of the lubricant. The notification system 50 has a disc 52 disposed in the hollow body 12, a sensor 54, a notification generator 56, and a controller 58 wirelessly connected to the sensor 54 and the notification generator 56.

The disc 52 is located in the hollow body 12 to be slidable with respect to the hollow body 12. The disc 52 is taken out from the hollow body 12 when the hollow body 12 is filled with the lubricant. When the hollow body 12 is filled up, the disc 52 is placed on the lubricant and the bottom cap 20 is closed. When the applicator device 10 is upside down, i.e., when the applicator 30 is facing down, the disc 52 is positioned on the fluid surface of the lubricant between the lubricant and the bottom cap 20. The disc 52 approaches the applicator 30 as a remaining amount of the lubricant in the hollow body 12 decreases.

The sensor 54 detects a fluid surface of the lubricant 14 by detecting the disc 52. The sensor 54 is a proximity sensor that detects the disc 52 without being in contact with the disc 52. More specifically, the sensor 54 may be a magnetic sensor and the disc 52 is made of a metal so that the sensor 54 detects the disc 52 based on a magnetic field of the disc 52. For example, the sensor 54 is attached to an outer surface of the hollow body 12. The sensor 54 is located proximate to the fluid inlet 36 of the applicator 30. Specifically, the sensor 54 is located a specified distance away from the fluid inlet 36 along a longitudinal direction of the hollow body 12. The sensor 54 outputs a detection signal when the disc 52 approaches the fluid inlet 36 the specified distance or closer. For another example, the sensor 54 outputs the detection signal when at least a part of the disc 52 comes in a specified area around the sensor 54.

The sensor 54 is connected to the controller 58 wirelessly. For example, the sensor 54 has a transmitter that converts a signal into a radio signal having a radio frequency and outputs the radio signal. The controller 58 is configured to receive the radio signal using a receiver. Upon receiving the radio signal, the controller 58 outputs an operation signal to the notification generator 56.

Upon receiving the operation signal, the notification generator 56 generates a notification signal to notify a user of the applicator device 10 that the remaining amount of the lubricant in the hollow body 12 is low. For example, the notification generator 56 may be a warning lamp that is turned on upon receiving the signal. For example, the notification generator 56 may be an alarm that generates sound upon receiving the signal. Thus, a user of the applicator device 10 can fill up the applicator device 10 before running out of the lubricant.

According to the present application, the notification system 50 is based on wireless sensor networks. Since the controller 58 is connected to the sensor 54 and the notification generator 56 without using wires or extension codes, a manufacturing cost of the applicator device 10 can be reduced. In addition, since the wires or extension codes are not necessary, the operator can use the applicator device 10 at anywhere. For example, the applicator device 10 can be used at a small place where it is difficult to arrange the wires or extension codes. Moreover, since the applicator device 10 does not need wires and the extension codes, the operator does not come in contact with wires and the extension codes. It result in securing safety and improving efficiency during the manufacturing processes.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. An applicator device for applying a fluid to an object, the applicator comprising:
a hollow body storing the fluid therein;
an applicator discharging the fluid;
a sensor configured to detect a fluid surface of the fluid; and
a notification system configured to generate a notification signal based on a detection signal from the sensor.

2. The applicator device of claim 1, wherein
the sensor is configured to output the detection signal when the fluid surface approaches the applicator a specified distance or closer.

3. The applicator device of claim 1, further comprising
a disc in the hollow body, wherein
the dis is located on the fluid surface, and
the sensor detects the fluid surface by detecting the disc.

4. The applicator device of claim 3, wherein the sensor is located outside the hollow body and detects the disc without being in contact with the disc.

5. The applicator device of claim 4, wherein
the disc is made of metal, and
the sensor is a magnetic sensor that is configured to detect the disc based on a magnetic field of the disc.

6. The applicator device of claim 3, further comprising
a bottom cap attached to the hollow body to be detachable, wherein
the applicator is located at one end of the hollow body and the bottom cap is located at another end of the hollow body along a longitudinal direction of the hollow body.

7. The applicator device of claim 6, wherein
the disc is located between the fluid surface and the bottom cap along the longitudinal direction of the hollow body.

8. The applicator device of claim 1, further comprising
a controller connected to the sensor and the notification system wirelessly, wherein
the controller is configured to receive the detection signal and outputs an operation signal to the notification system, and
the notification system generates the notification signal upon receiving the operation signal.

9. The applicator device of claim 8, wherein the notification system has a notification generator that is configured to receive the operation signal from the controller and that generates the notification signal upon receiving the operation signal.

10. The applicator device of claim 9, wherein the notification generator is a warning lamp that is turned on upon receiving the operation signal.

11. The applicator device of claim 9, wherein the notification generator is an alarm that generates sound upon receiving the operational signal.

12. The applicator device of claim 1, wherein
the applicator has a tip and a spring mechanically connected to the tip,
the spring is shrunk when the tip is pressed against the object and allows the fluid to come out from the tip.

13. The applicator device of claim 12, wherein
the applicator has a fluid inlet that is located in the hollow body and that takes in the fluid, and
the sensor is configured to output the detection signal when the fluid surface approaches the fluid inlet a specified distance or closer.

14. The applicator device of claim 12, wherein the tip is a brush in shape.
